(19) United States
(12) Patent Application Publication
(10) Pub. No.: US 2008/0065518 A1
(43) Pub. Date: Mar. 13, 2008

(54) Locking of settlements and documents during production of tax return

(75) Inventors: Siddhartha Sinha, Redmond, WA (US); Hans Jorgen Gron, Slangerup (DK); John Thuneby, Winchester, MA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/517,767

(22) Filed: Sep. 8, 2006

(51) Int. Cl. G07F 19/00

(52) U.S. Cl. 705/31

(57) ABSTRACT

A method is provided that identifies a tax event that is to be included in a tax document and creates the tax document based on the tax event. The tax event is then locked when saving the tax document so that the tax event cannot be edited or voided. In addition, tax liability created by the tax document is posted to a financial account as part of saving the tax document.

### BACKGROUND

In computer-based accounting systems, details of transactions such as invoices, payments, and bills are stored in a database. Many of these transactions have tax implications. In accrual-based accounting, the tax liability arises the day that the invoice is issued, or a payment on account is made or the day that a payment on account or bill from a supplier is received. In cash-based accounting, the tax liability arises at settlement when a payment is applied to an invoice or a bill.

An entire payment or a portion of a payment may be applied to an invoice or bill in a settlement. In addition, one payment may be used to settle multiple invoices or bills. Similarly, multiple payments may be applied to the same invoice or bill, giving rise to multiple settlements for the same invoice or bill.

In order to pay the tax associated with these taxable events, systems have been developed that look through the database to identify tax events and to generate a tax return to pay the tax associated with the tax events. Many of these systems mark events in the database that are used in a tax return. This marking is designed to prevent the events from being included in more than one tax return.

Although this marking is helpful, it may not prevent users from modifying the taxable event after the return has been filed. Such modifications are common in accounting systems and are used to correct errors. For example, an invoice may be modified to delete an item from the invoice because the item was never shipped. Because users are able to modify the taxable events after the return is generated, discrepancies between the tax return and the underlying events used to form the tax return can occur. Marking also may not indicate which tax return was used to report the transaction. As a result, the details of the transactions involved in the tax return cannot be retrieved at a later date.

Once the tax return has been generated, current systems require a separate manual step of posting the tax liability determined in the return on the accounts of the company. This separate posting step is time consuming and prone to error.

The discussion above is merely provided for general background information and is not intended to be used as an aid in determining the scope of the claimed subject matter.

### SUMMARY

A method is provided that identifies a tax event that is to be included in a tax document and creates the tax document based on the tax event. The tax event is then locked when saving the tax document so that the tax event cannot be edited or voided. In addition, tax liability created by the tax document is posted to a financial account as part of saving the tax document.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a flow diagram of a method of generating tax returns under one embodiment.

FIG. 2 is a block diagram of elements used to generate and view a tax return under one embodiment.

FIG. 3 is a flow diagram of steps for viewing and drilling down through a tax return under one embodiment.

FIG. 4 is a block diagram of one computing environment in which some embodiments may be practiced.

### DETAILED DESCRIPTION

Embodiments described herein lock taxable events that are involved in a tax return as part of generating that tax return. In particular, objects known as locking document lines and locking settlement lines are formed as child objects of a document object that represents the tax return. The locking document lines and locking settlement lines prevent the document or settlement that is being included in the tax return from being edited or voided. The locking document lines and locking settlement lines also uniquely identify the documents and settlement that are included in the tax return so that each document or settlement involved in a return may be viewed at a later date. Since the documents and settlements are locked, when they are viewed at a later date they will contain the same information that was used to form the tax return. This helps reduce discrepancies between the tax return and the underlying taxable events. In further embodiments, the tax liabilities determined in the tax return are automatically posted to the proper accounts in the accounting books as part of saving the tax return. As a result, a separate step of posting is not needed.

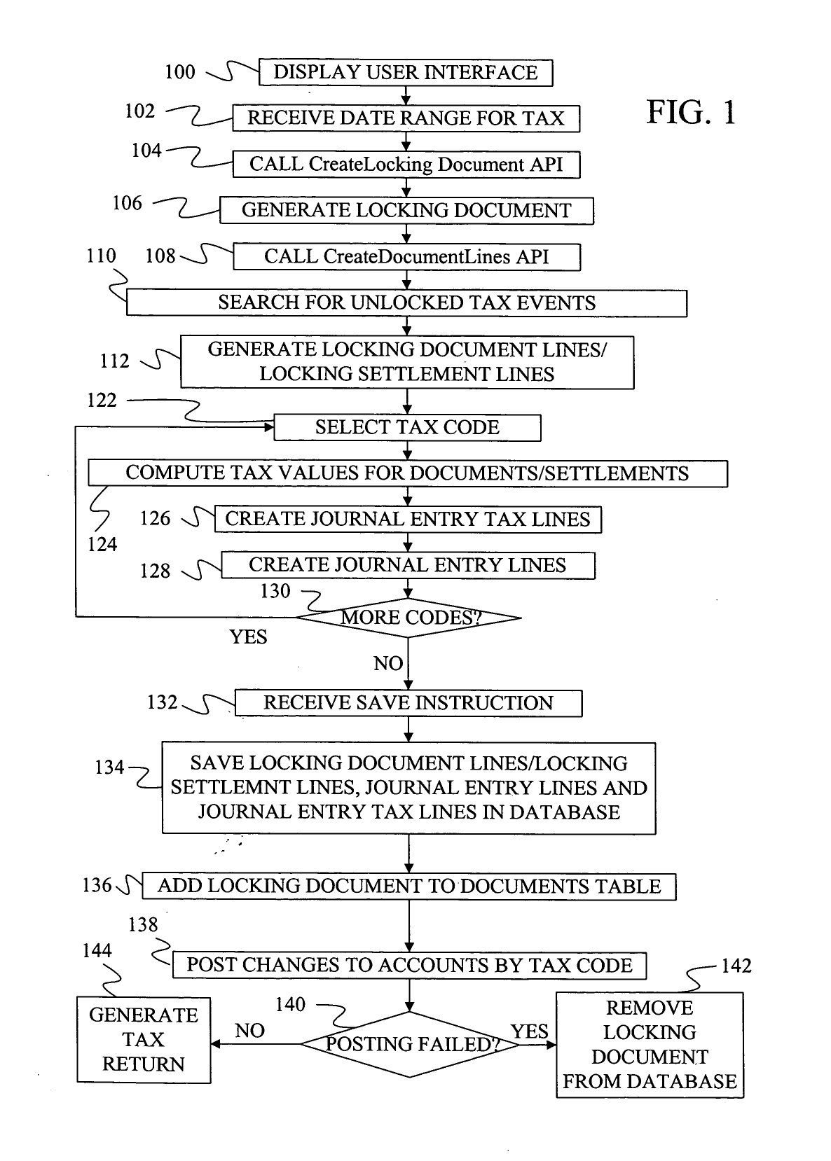

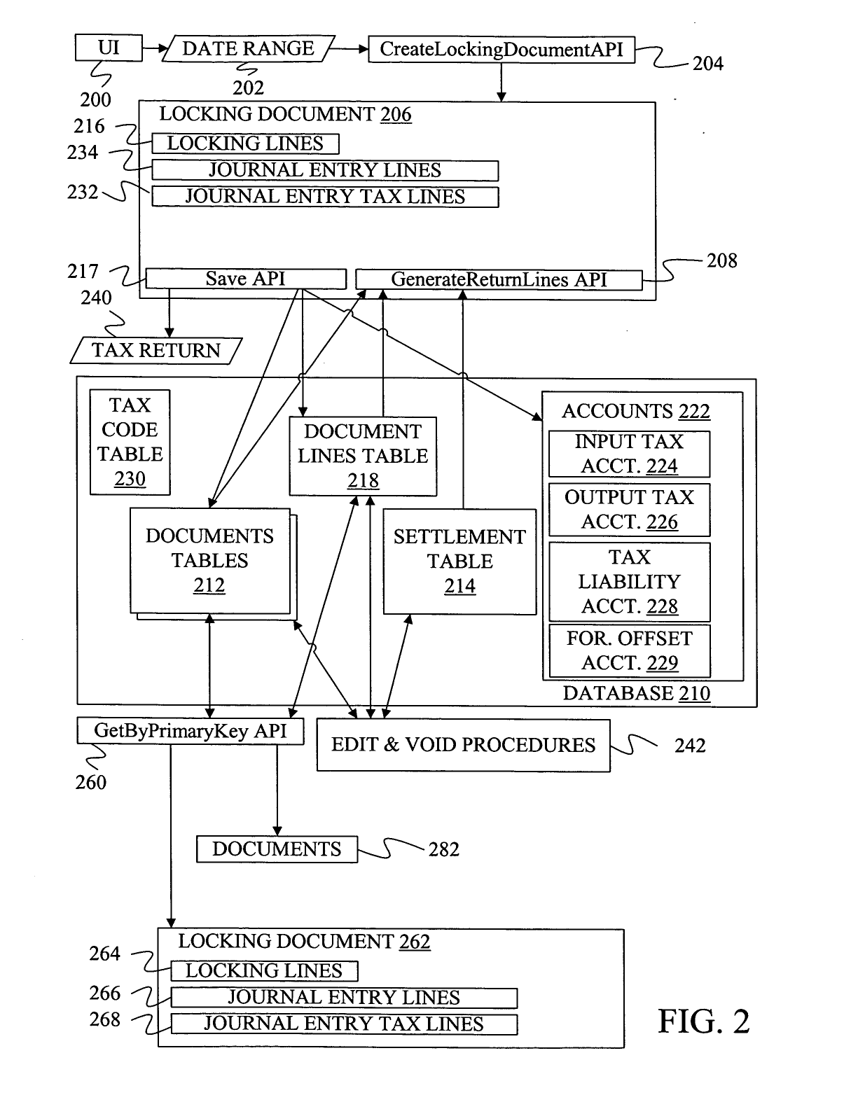

FIG. 1 provides a flow diagram of a method of generating a tax return under one embodiment and FIG. 2 provides a block diagram that shows elements used in the flow diagram of FIG. 1.

In step 100 of FIG. 1, a user interface 200 is provided to a user. Through the user interface, the user sets a date range 202 that the tax return is to cover. This date range is received at step 102 and is used to invoke CreateLockingDocument Application Programming Interface (API) 204 at step 104. CreateLockingDocument API 204 generates a tax document 206, referred to generically as a locking document, which is an object that represents the tax return that is to be produced. Locking document 206 exposes a GenerateReturnLines API 208, which is called at step 108.

At step 110, GenerateReturnLines API 208 searches a database 210 for events in the date range 202 that are not locked and affect a tax liability. In many embodiments, database 210 contains records for each accounting transaction that affects a company and electronic records of the books of accounts for the company (for example accounts receivable, accounts payable, input tax, output tax and tax liability). For accrual-based accounting, the search of step 110 involves looking in documents tables 212 of database 210 for documents that represent transactions such as invoices, payments and bills. For cash-based accounting, this search involves looking in settlements table 214 for settlements between payments and invoices or bills. In addition, in both accrual-based and cash-based accounting systems, the search of step 110 looks for pre-payment documents. A pre-payment document is a document that reflects payment before an invoice has been issued or a bill has been received. The term “tax event” is used herein to refer to documents and settlements that affect a tax liability.

In some embodiments, the search is extended to look for tax events that are dated before the date range. If such tax events are found and are not locked, they are considered corrections to previous tax returns. In some embodiments, these corrections are tracked separately when preparing the tax return.

Note that the documents and settlements found during the search cannot be locked again. Under embodiments described below, a document or settlement is locked when it is included in a locking document that is saved. By requiring the documents and settlements to be unlocked at step 110, this embodiment prevents a document or settlement from being included in more than one locking document. This ensures a tax event can be included only in one tax return. As described further below, document lines table 218 can be examined to determine if a document or settlement is locked.

At step 112, GenerateReturnLines API 208 generates locking document lines/locking settlement lines 216. Locking document lines and locking settlement lines are created based on the tax event to be locked. The locking document lines/locking settlement lines 216 are child objects of locking document 206. A locking document line contains the following properties:

| Property | Type |
|---|---|
| LockOriginalTransactionID | Integer |
| LatestDocumentModifiedDateTime | DateTime |
| DocumentLineID | Integer |
| DocumentLineType | Integer |
| OwnerDocumentType | Integer |

The LockOriginalTransactionID is a transaction ID associated with the document that generated the tax liability for this locking document line. Under some systems, documents can be edited and each version of the document that is saved is given its own transaction ID. However, every document in the chain of revisions shares the same original transaction ID, which is the transaction ID for the first version of the document in the chain. It is this first transaction ID that is stored in the LockoriginalTransactionID property.

The LatestDocumentModifiedDateTime property is the date/time stamp of the version of the document that generated the tax liability. This property is added as a consistency check to make sure that the correct version of the document is associated with the tax return.

The DocumentLineID property is the document line ID of this locking document line. In most embodiments, this property is set when the locking document is saved, which causes the locking document line to be added to document lines table 218.

The DocumentLineType property identifies this document line as a locking document line. Under some embodiments, there are a large number of possible document line types other than locking document line such as a locking settlement line, journal entry line, deposit line, expense line, and journal entry tax line.

The OwnerDocumentType property identifies locking document 206 as a locking document.

A settlement locking line contains the following properties:

| Property | Type |
|---|---|
| LockSettlementID | Integer |
| DocumentLineID | Integer |
| DocumentLineType | Integer |
| OwnerDocumentType | Integer |

The LockSettlementID property is the identifier in settlement table 214 for the settlement associated with this locking settlement line. The DocumentLineID and OwnerDocumentType properties are the same as for the locking document line. The DocumentLineType identifies this line as a locking settlement line. For accrual-based accounting, a separate locking document line is created for each document found during the search of step 110. In addition, a locking settlement line is created for each settlement of a pre-payment against an invoice or bill. For cash-based accounting, a separate locking settlement line is created for each settlement found during the search of step 110. In addition, a locking document line is created for each pre-payment document received during the reporting period.

In addition, a locking document line is added that includes the original transaction ID of the last locking document that was saved. This locking document line creates a chain of locking documents and prevents editing an early locking document unless a later locking document is voided first.

After the locking document lines or locking settlement lines have been added to the document, GenerateReturnLines API 208 begins computing values that need to be posted in financial accounts 222 to represent the creation or filing of the tax return. In one embodiment, postings are made to an input tax account 224, an output tax account 226, a foreign offset tax account 229 and a tax liability account 228. Input tax account 224 tracks the amount of tax credit that has not been accounted for in a tax return. Output tax account 226 tracks the amount of tax owed that has not been accounted for in a tax return. Foreign offset tax account 229 tracks the amount of tax credit associated with a foreign acquisition that has not been accounted for in a tax return. Tax liability account 228 tracks the amount of tax owed to the taxing authority based on tax returns that have been created.

Before the process of FIG. 1 begins, input tax account 224 has been debited each time a document or settlement has been saved that reduces the tax liability of the company. Similarly, output tax account 226 has been credited each time a document or settlement has been saved that increases the tax liability of the company. The amount of the debit or credit is equal to the amount of decrease or increase, respectively, in tax attributed to the document or settlement. When a document or settlement involves importing, input tax account 224 is debited and foreign offset account 229 is credited by the tax amount associated with the importation. In addition, in some embodiments, the postings are marked with a tax code that indicates the tax rate and type of tax applied to the tax event.

To begin the process of computing values that need to be posted to financial accounts based on filing the tax return, a tax code is selected from tax code table 230 at step 122. Using the locking document lines/locking settlement lines, documents/settlements in the date range provided by the user that have that tax code are identified. The total output tax and total input tax for those documents/settlements is then computed at step 124 by summing the output tax and the input tax, respectively, of those documents/settlements. The net tax liability is also computed based on the difference between the total output tax and the total input tax. In addition, document/settlements in the date range that involve an importation are also identified and the sum of the input tax associated with those transactions is determined.

At step 126, three journal entry tax lines 232 are added to locking document 206. Journal entry tax lines 232 are child lines of locking document 206 and are used to post credits to input tax account 224 and debits to foreign offset tax account 229 and output tax account 226. One of the journal entry tax lines 232 will be used to post a debit to the output tax account equal to the total output tax for the selected tax code. One of the journal entry tax lines 232 will be used to post a debit to the foreign offset tax account and a credit to the input tax account equal to the total input tax for imports for the selected tax code. The last journal entry tax line 232 will be used to post a credit to the input tax account equal to the total input tax for the selected tax code. These postings effectively remove the tax amounts that were added to these tax accounts by the documents or settlements in the date range with the selected tax code.

At step 128, two journal entry lines 234 are added to the locking document. Journal entry lines 234 are child lines of locking document 206 and are used to post credits and debits to tax liability account 228. One journal entry line 234 will be used to post a debit to tax liability account 228 that is equal to the credit posted to input tax account 224 by journal entry tax line 232. The other journal entry line 234 will be used to post a credit to tax liability account 228 that is equal to the debit posted to the output tax account 226 by journal entry tax line 232.

Together, journal entry tax lines 232 and journal entry lines 234 transfer the tax from input tax account 224 and output tax account 226 to tax liability account 228.

Note that when corrections to a previous period are made, such corrections can appear as unlocked tax events that occur before the date range set by the user. If such unlocked tax events were found during the formation of the locking document lines and locking settlement lines, the journal entry lines and journal entry tax lines will account for these corrections.

At step 130, GenerateReturnLines API 217 determines if there are more tax codes to process. If there are more tax codes, a different tax code is selected at step 122 and steps 124, 126, and 128 are repeated for the new tax code.

When there are no more tax codes at step 130, GenerateReturnLines API 208 returns to the caller. The caller then calls the Save API 217 at step 132. Save API 217 inserts the locking document lines, locking settlement lines, journal entry tax lines and journal entry lines into document lines table 218. Save API 217 then adds the locking document itself to documents table 212 at step 136. This insertion triggers the postings to input tax account 224, output tax account 226, foreign offset tax account 229 and tax liability account 228 at step 138. In particular the entries are posted per tax code.

If posting to any of the accounts fails at step 140, locking document 206 and all of its child document lines, including the locking document lines and locking settlement lines, are removed from database 210 and an error is reported to the user at step 142. Thus, posting to the accounts is integrated with saving locking document 206 to the database.

If the postings succeed, the saving of locking document 206 and its associated child document lines is complete and a tax return 240 can be generated at step 144 that may be filed with the taxing authority. Under one embodiment, tax return 240 lists the date range for the return, the total input tax, total output tax, total foreign offset (import) tax, and net tax liability for that date range on a per tax code basis.

Once locking document 206 has been saved, any documents or settlements that are identified in locking document lines or locking settlement lines cannot be edited or deleted. This prohibition is enforced by database procedures 242, which are used to edit and void documents and settlements in database 210. Specifically, when an edit or void procedure is called to edit or void a document or settlement, the procedure first looks in document lines table 218 to determine if there is a locking document line or locking settlement line for this document or settlement. If there is a locking document line or locking settlement line, the edit or void procedure returns an error. Note that since each locking document contains a locking document line pointing to the previous document, and void procedures 242 will not allow the previous locking document to be edited.

Although a locking settlement line prevents editing or voiding a settlement or editing or voiding the documents involved in a settlement, it does not prevent applying additional settlements between payments and bills/invoices that are involved in the settlement. Thus, if part of an invoice was settled with an earlier payment, a locking settlement line for that settlement would not prevent a new settlement from being formed between a later payment and the invoice.

Note that although the documents and settlements in a date range that are included in a locking document may not be altered, other documents and settlements may be added to the date range after the locking document has been saved. These additional transactions will not affect the locked documents and locked settlements and will not change the values in the locking document or the tax return. Thus, the period covered by the locking document is not locked. Instead, only the transactions that are included in the locking document are locked and cannot be edited or voided.

Using the locking document lines and locking settlement lines of the embodiments described above, a user is able to view a tax return filed for any previous period and see all of the details of the filing. In particular, since the locking document lines/locking settlement lines in the locking document list the documents or settlements that are included in the return, the locking document lines/locking settlement lines can be used to find every document or settlement that was included in the tax return. In addition, since the locking document lines and locking settlement lines prevent the documents and settlements from being changed or voided, the values for the tax return for any previous period will remain unchanged.

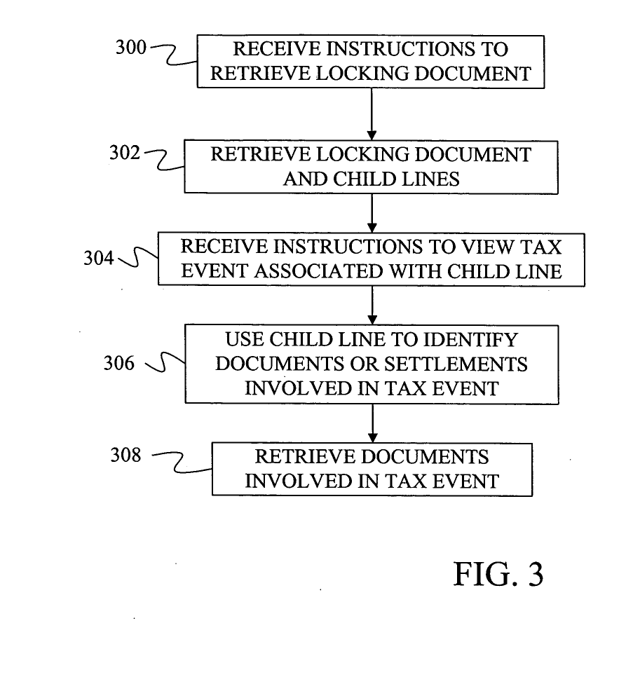

FIG. 3 provides a flow diagram of steps used to view details of a saved tax return document. In step 300, a request to view a saved tax return is received. In response, at step 302, a call to GetByPrimaryKey API 260 is made to create locking document object 262, which represents the saved tax return. The primary key required in this API is supplied by the caller to identify the locking document that needs to be retrieved. Note that although a primary key is used to retrieve the locking document in the example above, other API's may be used to retrieve the locking document using other parameters. For example, a GetByGuid API may be used to retrieve a document based on its GUID.

When a saved locking document is retrieved, a child line view of the document is initialized. To do this, GetByPrimaryKey API 260 uses database 210 to locate all child lines that were saved in document lines table 218 for the tax return. For each child line, a child object is created and is added to the child line view. This results in child line objects 264, 266, and 268.

Note that GetByPrimaryKey 260 does not perform a search of the database based on the date range for the tax return. Instead, it searches for child lines that had been saved when the locking document for the tax return was saved. As a result, tax events that fall within the date range of the tax return but that were not included in the tax return are not identified when forming child lines 264. Thus, only the tax events that were actually included in the tax return will generate child line objects 264 at step 302.

In particular, because the contents of the locking document are determined by the locking document lines and locking settlement lines and not by the date range of the locking document, back-dated transactions that are within the date range of the tax return will not be interpreted as being part of the tax return simply because the back-dated transaction is in the date range covered by the tax return.

At step 304, a request to view a tax event associated with a child line is received. Using the information in the child line, the document or settlement associated with the child line is identified at step 306. At step 308, the tax event that is identified is retrieved.

If the tax event is a document, database procedures are used to identify the primary key of the locked document using the original transaction id and the latest modified date stored in the child line. Then GetByPrimaryKey API 260 is used to create a document object 282 based on the identified primary key. If the tax event is a settlement, database procedures are used to identify the primary keys of documents involved in the settlement. GetByPrimaryKey API 260 is then used to create document objects 282.

The process of FIG. 3 may be used with a user interface. The user interface initially requests the locking document and displays the information returned for the locking document, including the information that describes the child lines of the locking document. If a user selects one of the child lines, the user interface sends the request for the tax event associated with that child line. The information is then returned to the user interface where it is displayed to the user. Thus, the user is able to “drill-down” through the tax return to look at documents that were involved in the tax return.

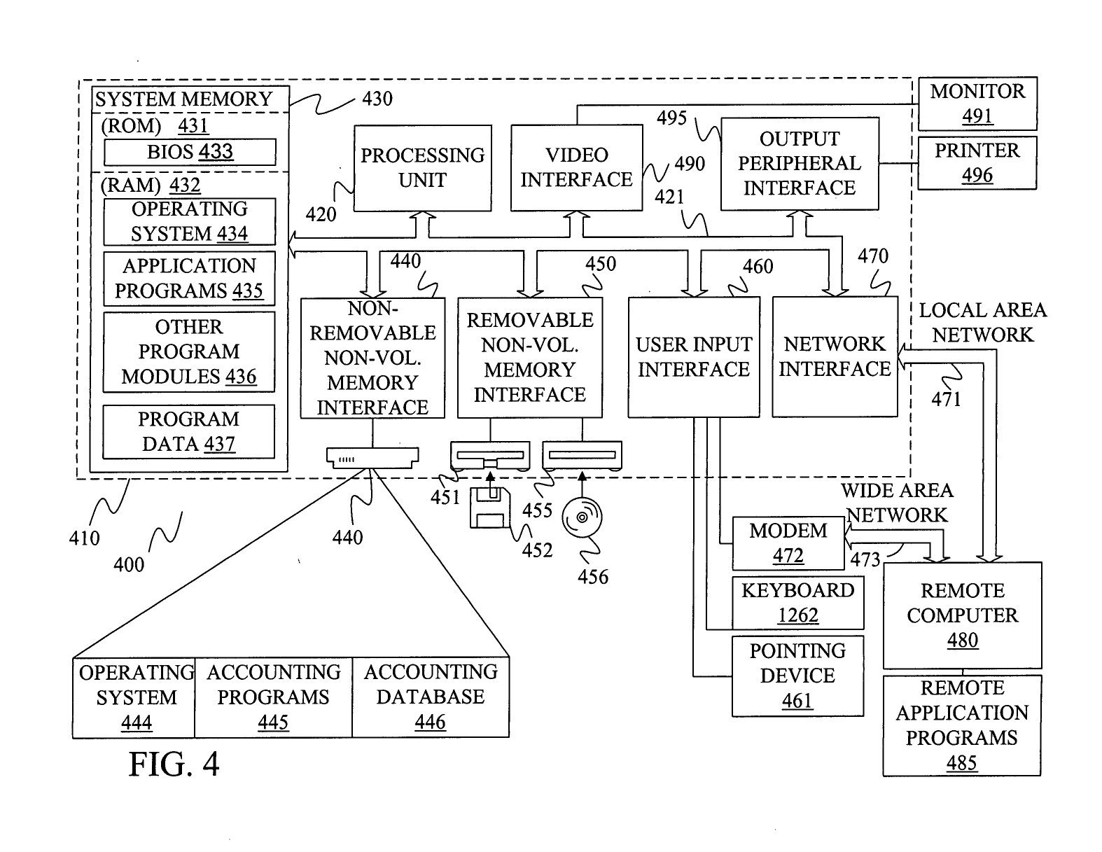

FIG. 4 illustrates an example of a suitable computing system environment 400 on which embodiments may be implemented. The computing system environment 400 is only one example of a suitable computing environment and is not intended to suggest any limitation as to the scope of use or functionality of the claimed subject matter. Neither should the computing environment 400 be interpreted as having any dependency or requirement relating to any one or combination of components illustrated in the exemplary operating environment 400.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 4, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, accounting programs 445, which provide the functionality of the embodiments described above, and accounting database 446, which provides database 210 described above.

A user may enter commands and information into the computer 410 through input devices such as a keyboard 462 and a pointing device 461. These and other input devices are often connected to the processing unit 420 through a user input interface 460 that is coupled to the system bus. A monitor 491 or other type of display device is also connected to the system bus 421 via an interface, such as a video interface 490. In addition to the monitor, computers may also include other peripheral output devices such as printer 496, which may be connected through an output peripheral interface 495.

The computer 410 is operated in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 4 include a local area network (LAN) 471 and a wide area network (WAN) 473, but may also include other networks.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on remote computer 480. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
identifying a tax event that is to be included in a tax document;
creating the tax document based on the tax event by including a locking line in the tax document; and
locking the tax event when saving the tax document based on the locking line in the tax document so that the tax event cannot be edited or voided.

2. The method of claim 1 wherein creating the tax document based on the tax event comprises forming a tax document object and creating child objects for the document object, where each child object represents a locking line for a tax event.

3. The method of claim 2 wherein a tax event comprises a document and a child object for the document comprises a locking document line.

4. The method of claim 3 wherein the locking document line identifies an original transaction ID for the document, wherein the original transaction ID represents the transaction ID of the first version of the document.

5. The method of claim 3 wherein locking the tax event comprises storing the locking document line in a database.

6. The method of claim 2 wherein a tax event comprises a settlement and a child object for the settlement comprises a locking settlement line.

7. The method of claim 6 wherein locking the tax event comprises storing the locking settlement line in a database.

8. The method of claim 1 further comprising posting changes to financial accounts when saving the tax document.

9. The method of claim 8 wherein posting changes to financial accounts comprises creating child objects for the tax document that represent postings to financial accounts, and using the child objects to post to the financial accounts.

10. The method of claim 1 further comprising locking a previous tax document when saving the tax document so that the previous tax document cannot be edited or voided.

11. A computer-readable medium having computer-executable instructions for performing steps comprising:
receiving an instruction to retrieve a stored tax return document;
creating a tax return object and child line objects based on the instruction;
receiving an instruction to retrieve a tax event associated with a child line;
using the child line to locate information related to the tax event; and
retrieving the information related to the tax event.

12. The computer-readable medium of claim 11 wherein the tax event is a document and wherein a child line object is created based on a locking document line in a database that is used to prevent changes to the document.

13. The computer-readable medium of claim 11 wherein the tax event is a settlement and wherein a child line object is created based on a locking settlement line in a database that is used to prevent changes to the settlement.

14. The computer-readable medium of claim 11 wherein the stored tax return comprises tax events for a date range and corrections for a previous tax return and wherein the child line objects are created without using the date range.

15. A method comprising:
creating a tax document;
calculating a tax liability to be reported using the tax document;
including the tax liability in the tax document; and
as part of saving the tax document, posting the tax liability to a financial account.

16. The method of claim 15 wherein calculating a tax liability comprises summing input taxes associated with a plurality of tax events to form a total input tax, summing output taxes associated with a plurality of tax events to form a total output tax, and taking the difference between the total output tax and the total input tax to form the tax liability.

17. The method of claim 16 further comprising posting the total input tax to an input tax account and posting the total output tax to an output tax account as part of saving the tax document.

18. The method of claim 15 wherein calculating the tax liability comprises calculating a separate tax liability for each of a plurality of tax codes and wherein posting the tax liability comprises posting a separate tax liability for each of the plurality of tax codes.

19. The method of claim 16 further comprising, as part of saving the tax document, saving locking document lines that are used to prevent changes to documents that affect the tax liability.

20. The method of claim 16 further comprising, as part of saving the tax document, saving locking settlement lines that are used to prevent changes to settlements that affect the tax liability.
